(19) United States
(12) Patent Application Publication
(10) Pub. No.: US 2007/0096585 A1
(43) Pub. Date: May 3, 2007

(54) AC motor stator

(75) Inventor: Chao-Chin Chung, Taoyuan Hsien (TW)

Correspondence Address: BIRCH STEWART KOLASCH & BIRCH, PO BOX 747, FALLS CHURCH, VA, 22040-0747, US

(73) Assignee: Kuen Yang Industrial Co., Ltd.

(21) Appl. No.: 11/263,835

(22) Filed: Nov. 2, 2005

(51) Int. Cl. H02K 1/00

(52) U.S. Cl. 310/216

(57) ABSTRACT

An AC motor stator includes a plurality of thin silicon steel plates laminated, and said silicon steel plates have a plurality of wire grooves formed inclined for a certain angle to the outer surface of the stator. So when the coil wound continuously around each section between every two neighboring wire grooves of the stator, the magnetomotive force generated at those sections may be evenly distributed and are continuative to one another so the power of the AC motor may be boosted.

### BACKGROUND OF THE INVENTION

1. Field of the Invention

This invention relates to an AC motor stator, particularly to one provided with a plurality of wire grooves and magnetomotive forces generated by wires of a coil wound around each section between every two neighboring wire grooves of the stator are continuative to one another, so the power of the motor may be upgraded.

2. Description of the Prior Art

A conventional AC motor stator 30 shown in FIGS. 1 , 2 and 3 is made of plural thin silicon steel plates 3 1 laminated, and the thin silicon steel plates 31 are respectively provided with a center hole 32 for receiving a rotor 40 therein, and a plurality of wire grooves 33 are axially formed spaced apart equidistantly around the wall defining the center hole 32, and wires of a coil are wound around each section between two every neighboring wire grooves 33. having respectively an opening 330 communicating with the center hole 32. When the coil is electrified, the wires of the coil wound around each section between every two neighboring wire grooves 33 may generate magnetomotive force to force the rotor 40 to rotate. As the wire grooves 33 of the conventional AC motor stator 30 are formed axial, so the magnetomotive force generated by each section between every two neighboring wire grooves 33 is feeble, causing the whole magnetomotive force not distributed evenly and not continuative, so the power of the motor is affected.

### SUMMARY OF THE INVENTION

This invention has been devised to offer an AC motor stator generating the magnetomotive force evenly distributed and each magnetomotive force generated by each section of wires of the coil in each wire groove continues with one another to boost the power of the motor.

The feature of the AC motor stator in the invention is wire grooves of the stator are formed to incline for a certain angle to the outer surface of the stator in the same direction, enabling the magnetomotive force generated by the wires of the coil in each section evenly distributed and continue to one another,

### BRIEF DESCRIPTION OF DRAWINGS

This invention will be better understood by referring to the accompanying drawings, wherein:

FIG. 1 is an exploded perspective view of a conventional AC motor stator;

FIG. 2 is an upper view of the conventional AC motor stator and the rotor;

FIG. 3 is an upper view of the conventional AC motor stator with the rotor fitted in the stator;

FIG. 4 is an exploded perspective view of an AC motor stator in the present invention;

FIG. 5 is an upper view of the AC motor stator and the rotor in the present invention;

FIG. 6 is an upper view of the AC motor stator and the rotor fitted in the stator in the present invention; and,

FIG. 7 is a side cross-sectional view of the AC motor stator and the rotor in the present invention.

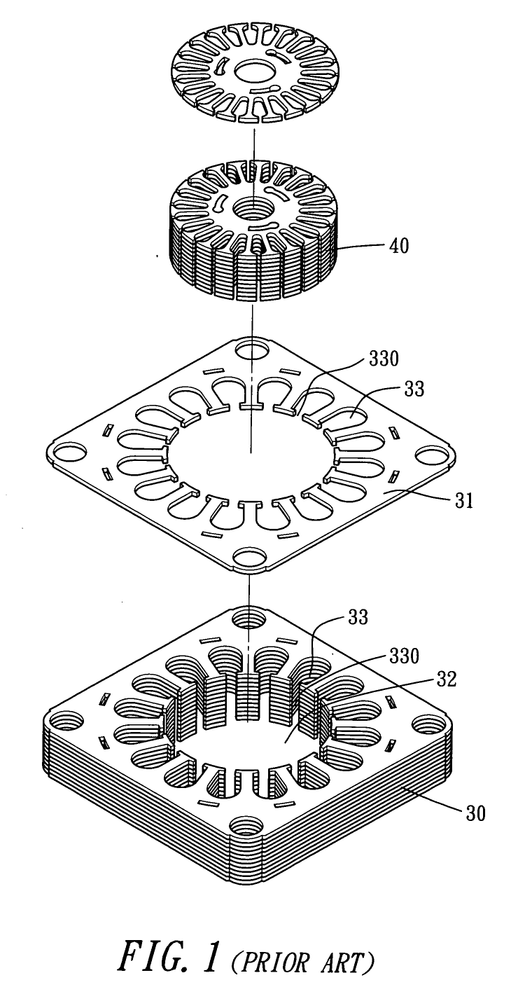

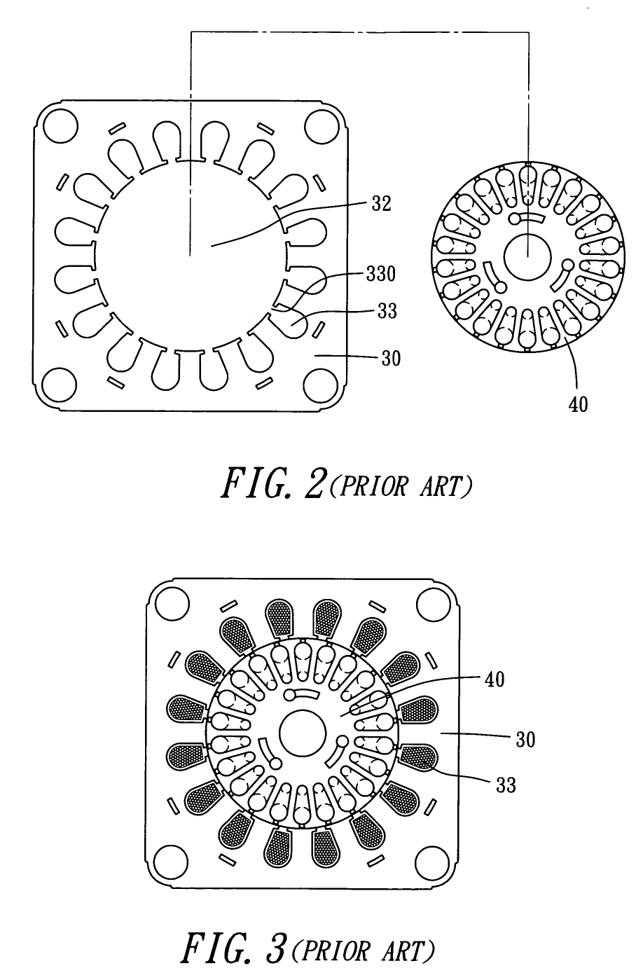

### DETAILED DESCRIPTION OF THE PREFERRED EMBODIMENT

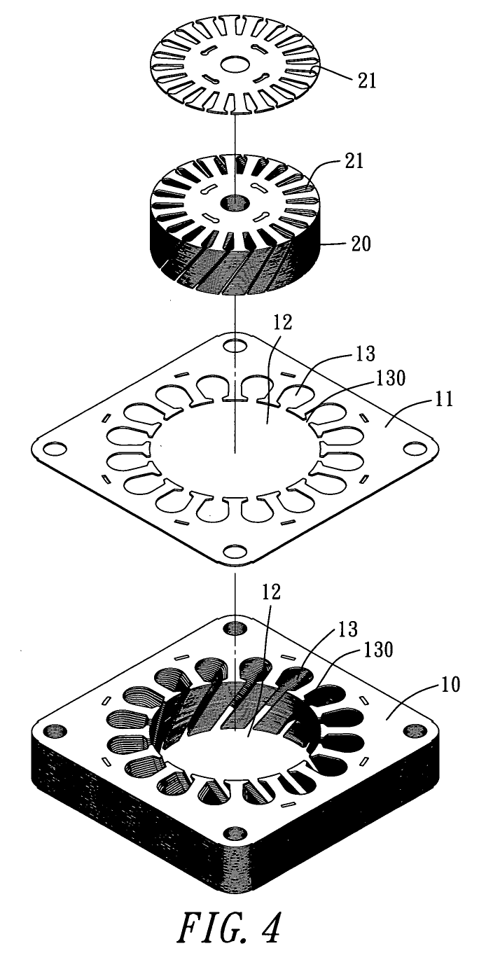

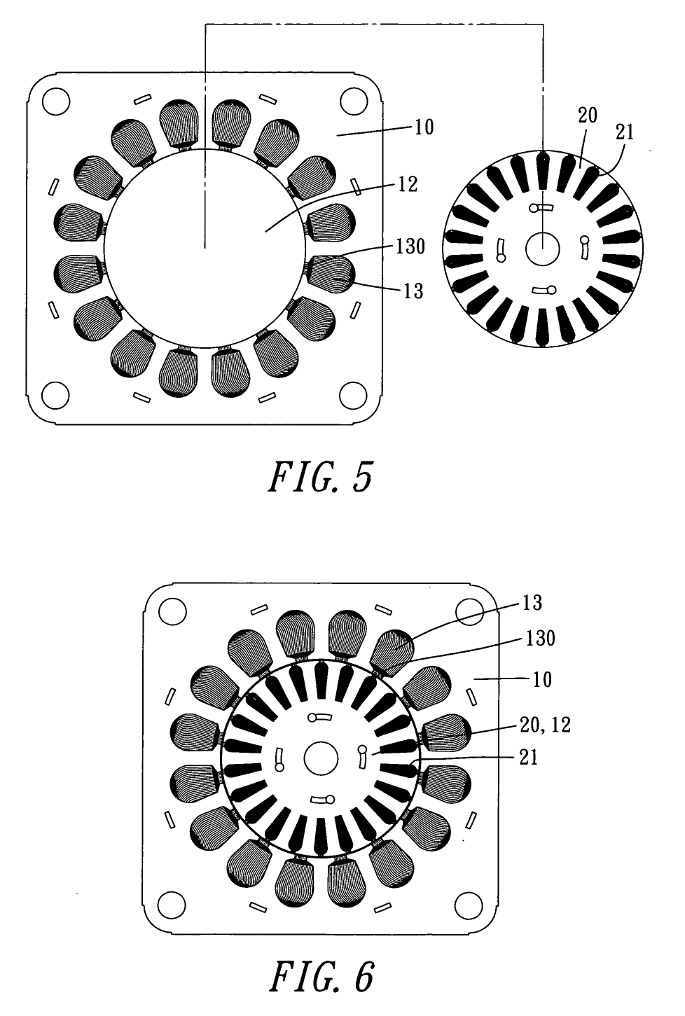

A preferred embodiment of an AC motor stator in the present invention, as shown in FIGS. 4, 5, 6 and 7, includes a plurality of thin silicon steel plates 11 laminated, and the thin silicon steel plates 11 are respectively provided with a center hole 12 for receiving a rotor 20 therein, and a plurality of wire grooves 13 spaced apart equidistantly around the wall defining the center hole 12 for each part of wires of a coil to be received therein. Each wire groove 13 has a narrow opening 130 communicating with the center hole 1.

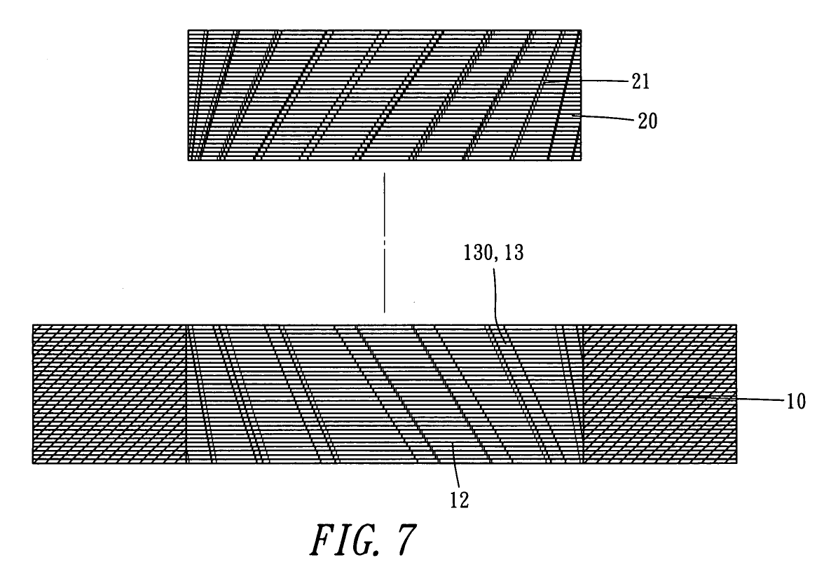

The wires grooves 13 of the stator 10 are formed inclined in a certain angle to the surface of the stator 10, and positioned in parallel with one another. So when the coil is electrified, the magnetomotive forces generated by the sections between every each two neighboring wire grooves 13 are continuative with one another to boost the power of the motor. Further, the openings 130 of the wire grooves 13 are also formed to incline as are the wire grooves 13 themselves, and the inclined direction of the wire grooves 13 of the stator is made to be opposite to that of the grooves 21 of a rotor 20, which are formed also inclined for a certain angle and also parallel to one another, as shown in FIGS. 4 and 7.

It is quite important that the wire grooves 13 of the stator of an AC motor are formed not straight but inclined for a certain angle to the surface of the stator, so the sections between every two neighboring wire grooves 13 may have the magnetomotive force generated as continuative to each other so as to upgrade the power of the AC motor and permitting the rotor 20 to rotate smoothly.

While the preferred embodiment of the inventin has been described above, it will be recognized and understood that various modifications may be made therein and the appended claims are intended to cover all such modifications that may fall within the spirit and scope of the invention.

What is claimed is:

1. An AC motor stator comprising a plurality of thin silicon steel plates laminated, said silicon steel plates having a center hole for receiving a rotor therein and a plurality of wire grooves formed spaced apart equidistantly around the wall defining said center hole, each said wire groove having a narrow opening communicating said center hole, said wire grooves formed inclined for a certain angle to an outer surface of said stator and in parallel to one another.

2. The AC motor stator as claimed in claim 1, wherein said rotor has a plurality of grooves spaced apart equidistantly around near the outer circular circumference, and said grooves are inclined for a certain angle to an outer surface of said rotor, and the inclined direction of said grooves of said rotor is opposite to that of said stator.

3. The AC motor stator as claimed in claim 1, wherein said openings of said wire grooves of said stator are also inclined as said wire grooves are.
